(19) United States
(12) Patent Application Publication
(10) Pub. No.: US 2008/0024359 A1
(43) Pub. Date: Jan. 31, 2008

(54) System and method for geometric apodization

(75) Inventors: William W. Watkins, Melbourne Beach, FL (US); Emile Ganthier, West Melbourne, FL (US); Kenneth J. Hendrickson, Melbourne, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Harris Corporation

(21) Appl. No.: 11/492,396

(22) Filed: Jul. 25, 2006

(51) Int. Cl. G01S 13/90

(52) U.S. Cl. 342/25 A; 342/159; 342/194; 342/195; 342/25 D; 342/25 F

(57) ABSTRACT

A complex image is apodized to suppress sidelobes. An original complex image of an object is received. The complex image comprises a plurality of data points and sidelobes. The complex image is transformed to a k-space image which is then trimmed to remove all points outside of a geometric shape. This trimming is done with the shape overlaying the image and being at a first angle with respect to the image. The trimming produces a trimmed k-space image. The trimmed k-space image is then converted back to a new complex image having a sidelobe structure different from the original complex image. The new complex image is then normalized by adjusting its intensity such that its peak amplitude matches a peak amplitude in the original complex image. A minimum function is then performed on the magnitudes of the original and new complex images. The result is an apodized image with suppressed sidelobe structure.

### FIELD OF THE INVENTION

The invention disclosed broadly relates to the field of digital signal processing, and more particularly relates to the field of removal of sidelobes.

### BACKGROUND OF THE INVENTION

The removal of sidelobes from sampled images is a common problem in image processing. Sidelobes are an artifact of limited bandwidth. Basically the sidelobe structure is created by the particulars of the collection of the data. Sidelobes are commonly seen as a starburst affect on each scatterer in an image. Sidelobes in an image hinder an image analyst's ability to detect weak targets or see dim sections of an image.

Sidelobes have a tendency to raise the noise floor in an image. This in turn has a tendency to obscure dim objects in a scene. Dim objects that are in proximity of bright objects are particularly affected. Although sidelobes are not part of the real scene, sidelobes are actually present in the raw data representing the scene. Therefore any removal of sidelobes is extrapolation of data. In other words, to remove sidelobes, information not otherwise present must effectively be added. An everyday example of adding information is the process of making an assumption. In conventional 2D image processing, sidelobes are conventionally thought of only in 2 dimensions. However, when data is rigorously processed in the full 3D volumetric counterpart, there are sidelobes in all dimensions. Sidelobes in the third dimension are often very significant. Consequently reduction of sidelobes in that dimension is also highly desirable.

An ideal removal or suppression of sidelobes makes a minimum number of assumptions or makes all of the correct assumptions and only removes sidelobes (which are a collection artifact) and not actual image data. There are many sidelobe removal techniques but they all have different limitations or different side effects. There is a need for a method and system to suppress sidelobes that does not result in loss of resolution, does not have specific collection criteria and that does not negatively affect the image. In essence, there is a need for techniques that more reliably creates the data that was missed when the measurement system took the raw sampled measurements.

Windowing is a well-known method for reducing sidelobes, but it has the drawback of increasing the width of the mainlobe, which reduces image resolution. Spatially Variant Apodization is a well-known method for reducing sidelobes, but it has the drawback of requiring specific collection criteria and/or re-sampling of the original data if it does not meet these criteria.

### SUMMARY OF THE INVENTION

Briefly, according to an embodiment of the invention, a complex image is apodized to suppress sidelobes. An original complex image of an object is received. The complex image comprises a plurality of data points and sidelobes. The complex image is transformed to a k-space image which is then trimmed to remove all points outside of a geometric shape. This trimming is done with the shape overlaying the image and being at a first angle with respect to the image. The trimming produces a trimmed k-space image. The trimmed k-space image is then converted back to a new complex image having a sidelobe structure different from the original complex image. The new complex image is then normalized by adjusting its intensity such that its peak amplitude matches a peak amplitude in the original complex image. A minimum function is then performed on the magnitudes of the original and new complex images. The result is an apodized image with suppressed sidelobe structure.

### BRIEF DESCRIPTION OF THE DRAWINGS

FIG. 1 is an original image with sidelobes. Intensity scale is DB.

FIG. 2, is the image of FIG. 1 transformed into k-space.

FIG. 3 is a trimmed version of the k-space shown in FIG. 2.

FIG. 4 is the corresponding image created from the k-space in FIG. 3.

FIG. 5 is an apodized image after one trimming iteration.

FIG. 6 is the corresponding k-space to the image in FIG. 5.

FIG. 7 shows a second trimming iteration of the original k-space shown in FIG. 2.

FIG. 8 is the corresponding image created from the k-space in FIG. 7.

FIG. 9 is an apodized image after two iterations.

FIG. 10 is the k-space transform of the apodized image of FIG. 9.

FIG. 11 is an apodized image after 31 iterations.

FIG. 12 is a k-space trim box that is 0.4 the width of the sample space.

FIG. 13 is a k-space trim box that is 0.5 the width of the sample space.

FIG. 14 is an apodized image after 93 trims, using 31 trims at 0.3, 0.04, and 0.5 the width of the sample space trim box.

FIG. 15 is a k-space transform of the image of FIG. 14.

FIG. 16 is a zoomed-in magnitude plot of a single range slice through the original image versus an apodized image.

FIG. 17 is a magnitude plot of a piece of a single X-range line of an original versus an apodized image.

FIG. 18, is a zoomed-in of the FIG. 17 magnitude plot of X-range line of an original versus the apodized version.

FIG. 19 is a flowchart illustrating a method according to an embodiment of the invention.

### DETAILED DESCRIPTION

The above problems are solved by a method and system called geometric-based apodization (GBA) which uses the concept of trimming k-space data with a varying trim shapes (i.e., geometry), varying sizes of the trim shapes, and varying orientation of the trim structure (i.e., rotation), as well as varying translated positions of the “trim” in k-space, to control the direction of the sidelobes. In the embodiment discussed herein the trimming utilized is square trimming but other shapes can also be used. In this embodiment square shape is used to remove all points outside the square.

The embodiment now discussed is a method operating on a synthesized set of point targets. This original image is approximately 0.6 meter resolution in range and azimuth in the native slant plane. The example image is a SAR (Synthetic Aperture Radar) image formed from broadside beam dragging from short range utilizing 40 degree beamwidth. The data is rendered at 0.5 meter pixel spacing in the ENU (East, North, Up) Plane. The instrument taking the SAR data is an airplane flying heading due north. The data is then downloaded to a computer for processing.

The notation of R will be used to mean the projection of the range into the ENU plane and the notation of X will be used for the projection of the cross range data into the ENU plane. Since the airplane collecting the SAR data is flying approximately due north, then R is very closely related to East (Left to Right) and X is very closely related to North (Bottom to Top).

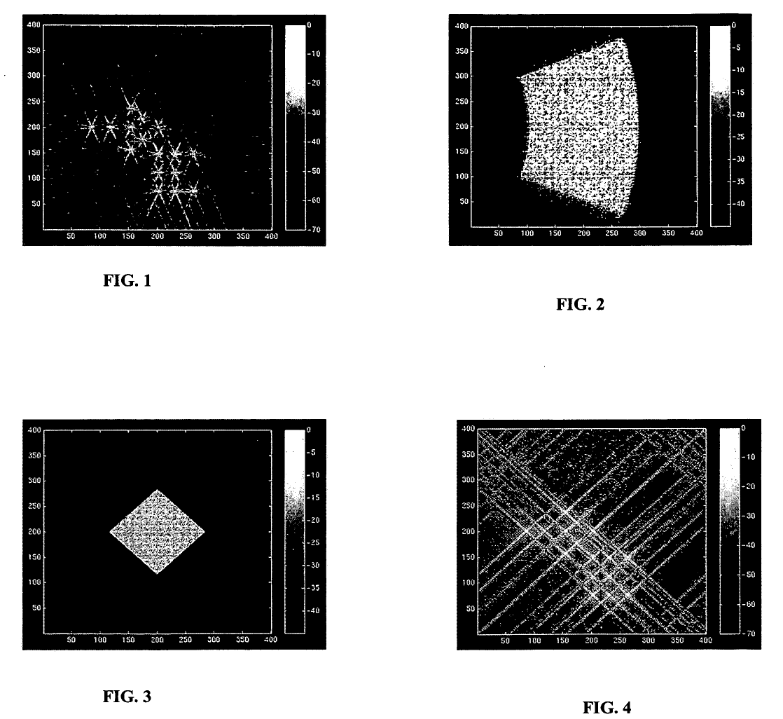

Starting with a complex image (FIG. 1), the image is transformed to a k-space image (FIG. 2) and trimmed about the center of the collect in azimuth and spatial frequency. A geometric shape is selected to trim the image (i.e., remove digital data outside the shape). In the embodiment discussed herein the shape is a square but any other suitable shape can also be used. The geometric shape is then used to trim at a first angle (FIG. 3). The trimmed k-space is then converted back to image space (i.e., the complex image). The resulting lower resolution image is formed (FIG. 4). A point by point “Minimum” function of the magnitude of the original image and the lower resolution image is then performed and the resulting apodized image is produced. This process is repeated with “trims” of varying shape, size, and rotation angles, at varying translated positions.

A first example utilizes the actual SAR data collection described above. However, the phase history has been replaced with synthetic data for the purpose of demonstrating and evaluating this apodization process.

Referring to FIG. 1, the first step is to form the original complex image using standard image formation techniques. Then the resultant image is transformed into k-space. This is performed by software applying a 2D or 3D Fast-Fourier Transform (FFT). FIG. 2 shows the image of the k-space. The original image has sixteen targets with equal magnitude and there are no other targets. Some targets are centered in the pixels and others are purposely placed off center (so their energy appears in at least two pixels). The magnitude detected 400×400 pixel image is rendered with a 70 DB scale. This high intensity scaling clearly displays the sidelobe structure.

Next, the k-space image of FIG. 2 is trimmed by a square that is oriented 45 degrees from the dominant orientation of the original k-space image of FIG. 1. The magnitude image of the trimmed k-space is shown in FIG. 3. The trimmed k-space is then transformed back to the complex image space (e.g., by using an inverse FFT). The resulting magnitude detected image is depicted in FIG. 4. This image is a lower resolution image with sidelobes that are generally rotated 45 degrees from the original sidelobes.

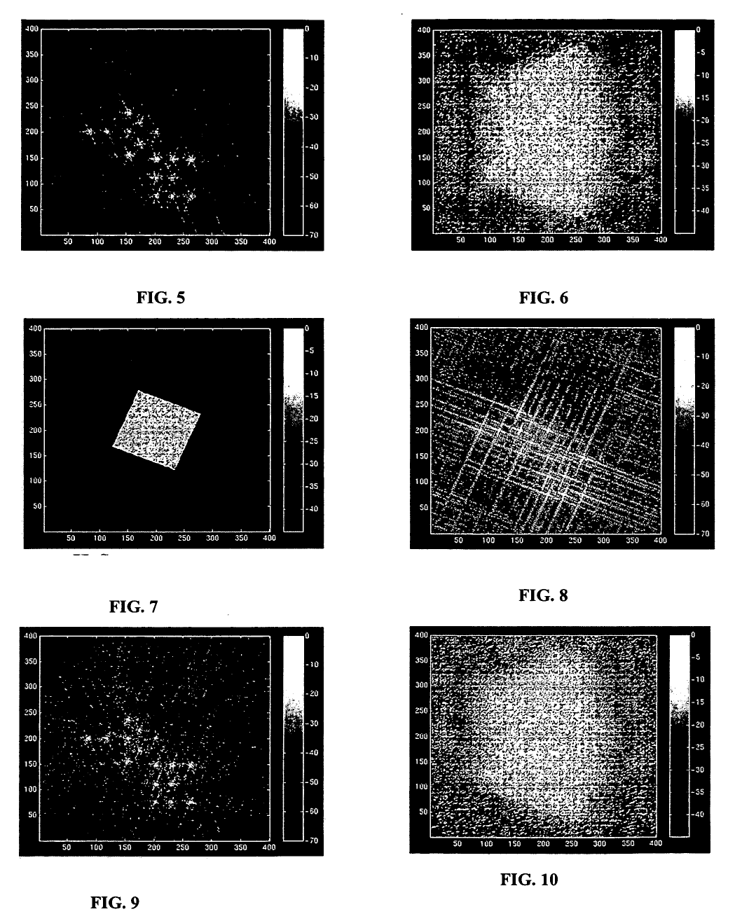

The next step is to take the Minimum function of these two complex images (i.e., FIG. 1 and FIG. 4). The result of the Minimum function is a single pass apodized image, shown in FIG. 5, that has been formed with a single iteration. This apodized image has some moderate sidelobe reduction. FIG. 6 is a k-space of the apodized image, shown for purposes of illustration. The process can stop here and provide this image as the final result or additional iterations of the foregoing process can be performed to provide improved results. The additional iterations can be performed with each iterative result being used to improve the apodized image. Alternatively the individual subaperature (e.g., different geometric shapes) images can be set aside and then a Minimum function applied to all (including the original image) of them at once to produce the final apodized image.

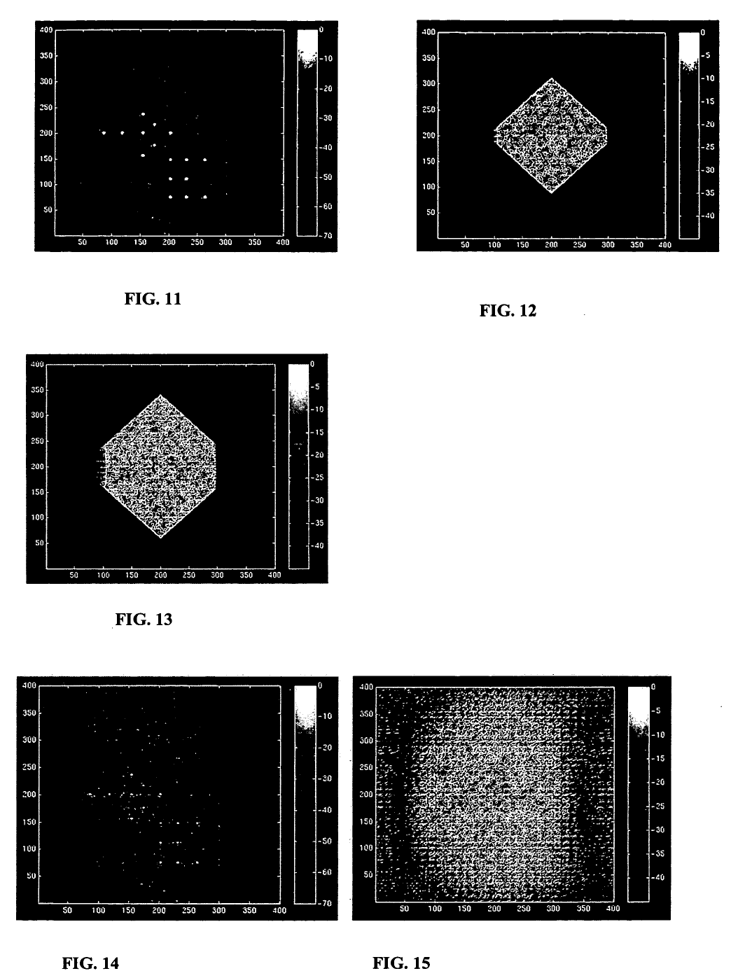

The second iteration is performed using a different angle of the trimming box that results in the trimmed image shown in FIG. 8. The trimmed k-space in FIG. 7 shows how the trimming takes place with a different angle. The angular rotation of the trim order employed attempts to reduce the sidelobes by rotating the trim space in an efficient and prudent manner. Each subsequent iteration (see apodized image after two iterations at FIG. 9, and corresponding k-space at FIG. 10) changes the angle of the trimming box. For example, the angles 45, 22.5, 67.5, 11.25, 33.75, 56.25 and 78.75 degrees are used for a seven iteration trim. This staggered progressive angular rotational order provides a rapid and orderly suppression of sidelobes. FIG. 11 is the apodized image after thirty one iterations.

If improved apodization that suppresses sidelobes very close to the targets is desired, using increasingly large squares for the trimming of the image will be required. In the example discussed herein the fist set of thirty-one iterations uses a 0.3 width of the sample space. The next set of iterations uses a trim box that is now 0.4 width of the sample space is used. This step improves sidelobe suppression very close-in to the individual targets. However the close-in suppression is not quite as deep as the suppression farther out. The reduced sidelobe suppression is due to the trim box extending beyond the bounds of the data in the k-space annulus. See FIG. 12 for an illustration of the how the k-space is limited on the right and left tips of the trimming box when the box is 0.4 of the width of the sample space. This phenomenon is even more prominent in FIG. 13 when the trimming box is increased to width of 0.5 of the sample space.

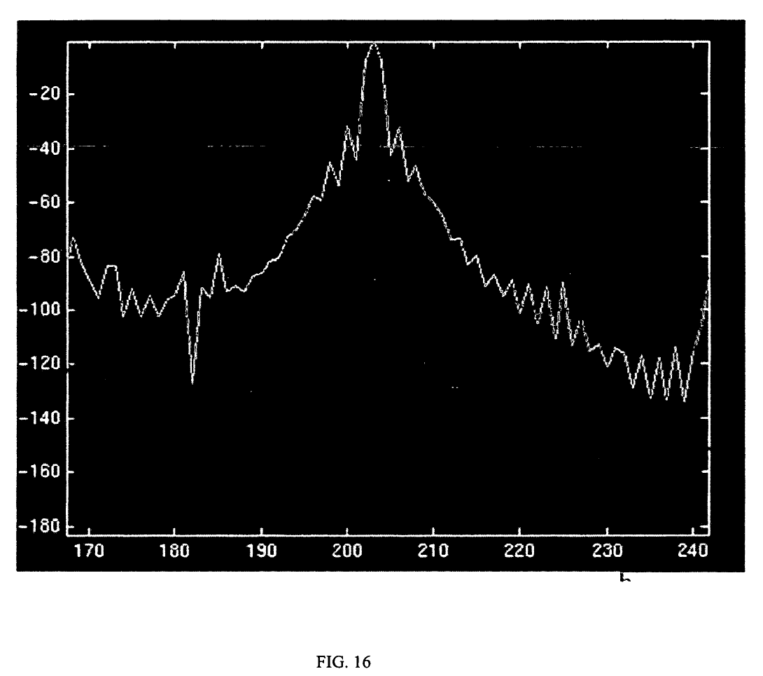

Continuing to increase the size of the trim box, in this case a 0.5 sample space. The sidelobe suppression is reduced but the suppression is once again nearer to the individual scatterers. Combining the trims (0.3, 0.4, 0.5) results in the image shown in FIG. 14 with its corresponding k-space (FIG. 15). The results shown in FIG. 14 are very good with extremely good sidelobe suppression and no loss of resolution.

Rotating is only one of the operations that can be done to apodize an image. In other operations the box can be rotated or translated and/or different shapes can be used. For example, a square at 45 Degrees can be used for a first pass, a pentagon for a second, and a rotated triangle for a third.

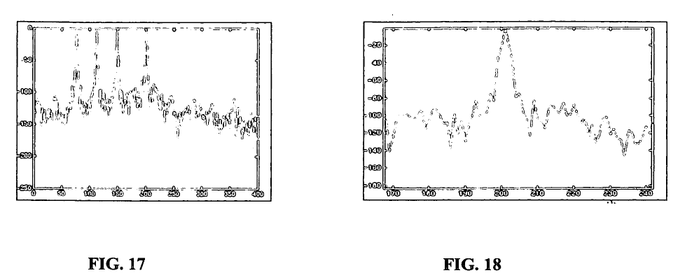

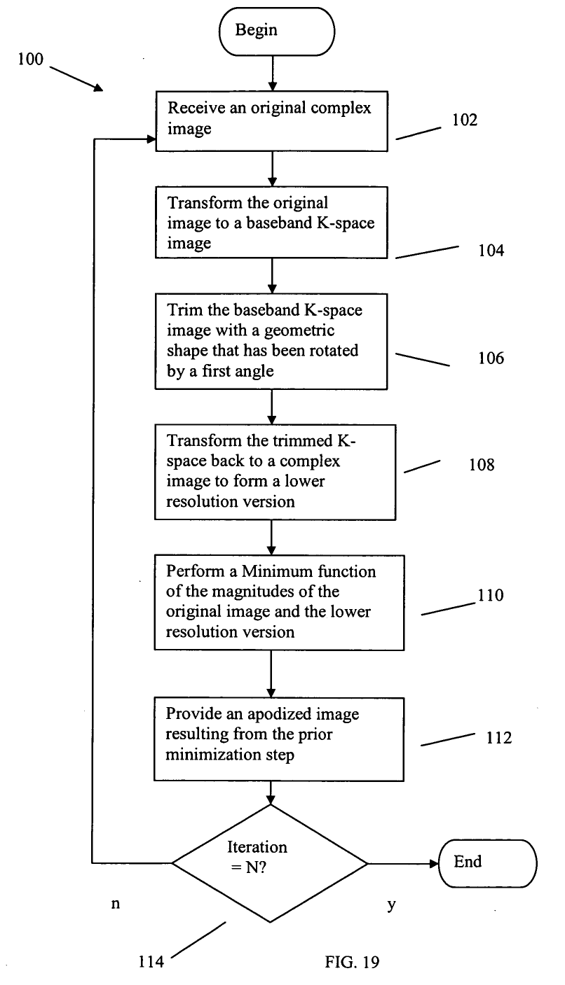

Plotting the amplitude of a single cross range line X (Bottom to Top) of the original image and the same cross range line from the apodized image through the center of the images, (see FIG. 17 and 18) the plot shows deep sidelobe suppression with no noticeable negative affect to the actual target return. This zoomed in magnitude plot shows the target image and the apodized image. Notice that the sidelobes are deeply suppressed but the actual target is virtually unaffected.

Referring to FIG. 16, for this case, the geometries of the k-space were such that the range sidelobe suppression is expected to be inferior to the azimuth sidelobe. This is because the larger trim boxes exceed the spectral frequency of the k-space but do not exceed the azimuth frequency. Close examination of the amplitude plot of a line R (Left to Right) of the original image and the apodized image across the center of the images shows very nice sidelobe suppression but realistically not quite as close in to the target. Notice that the sidelobes are deeply suppressed but the actual target is again virtually unaffected.

The final result is excellent, with extensive sidelobe suppression. However, this result has basically run the iterative process to exhaustion. Certainly a small improvement could be had by adding in additional cycles and additional trim sizes but the differences are negligible after fifteen iterations and three appropriate variations in the trimming size. It is apparent that running an iterative process to exhaustion is often too costly for many applications. A smaller number of iterations may be used.

The apodization schemes discussed above work with any geometric shape, not just squares. For example, a triangle, pentagon, or other geometric shape work as well. The shape may be regular or irregular, symmetric or non-symmetric. Furthermore, when working in full three dimensional (volumetrically) processing three-dimensional geometric shapes need be used to suppress the out of plane sidelobes. In those cases, any set of three-dimensional geometric shapes, for example a cube, may be used. K-space data outside of the three-dimensional shape is trimmed, similarly to the two-dimensional case. One example is the use of a tumbling cube in subsequent iterations on the 3D k-space. Similar to the 2D image apodization process, the 3D k-space is converted back into volumetric image domain and a minimum function is then performed iteratively to provide an apodized volume.

Geometric based apodization works well for significantly reducing sidelobes. In addition, the images that are produced do not show a common grainy artifact or the appearance of thresholding that is generated by many forms of apodization. Geometric apodization and other apodization techniques create (extrapolate) new information when they improve the images. The quality of these algorithms can be evaluated in terms of how well they extrapolate this information. Geometric Apodization uses “trims” of varying shape, size, rotational angles, and translated position to generate images in which the sidelobe energy from each scatterer is moved to multiple different image positions; these multiple images are then used to form a single image with the sidelobe energy suppressed. Furthermore, image bandwidth is preserved and no special sampling requirements exist for the image sensor.

Referring now to FIG. 20, there is shown a block diagram of a flowchart illustrating a method 100 according to an embodiment of the invention. Step 102 receives a complex original image with sidelobes. Step 104 converts the original image to a k-space image. Step 106 trims the k-space image with a geometric shape that is at a first angle with respect to the dominant k-space orientation (and the angle changes in each iteration). Step 108 transforms the trimmed k-space image back to the complex form of the original image. Step 110 performs a Minimum function on each corresponding set of points from each image. Step 112 provides an apodized image. In decision 114 the method then determines whether N iterations have been performed. If the number of iterations is not N, the method is performed again and if the method is at iteration number 20, the method ends.

The geometric apodization system discussed herein has several applications. The discussion above was of an embodiment where geometric apodization was used to suppress sidelobes to view dimmer objects near the apodized object. In another application, geometric apodization is used to detect man-made objects. It has been observed that when an image is apodized in a first iteration using a geometric shape for trimming to produce a first apodized image and in a second iteration the geometric shape is translated and the image is trimmed again producing a second image, a data point present in the first image that is not present in the second apodized image corresponds to an object that may be a manmade object.

Therefore, while there has been described what is presently considered to be the preferred embodiment, it will be understood by those skilled in the art that other modifications can be made within the spirit of the invention.

What is claimed is:

1. A method of apodizing a digital image for suppressing sidelobes, comprising steps of:
receiving an original complex image of an object, the image comprising a plurality of data points some of which form an original sidelobe structure;
transforming the original complex image to a k-space image
trimming the k-space image to remove all points outside a geometric shape, the trimming is done with the shape being at a first angle with respect to the k-space image to produce a trimmed k-space image;
transforming the trimmed k-space image back to complex form to produce a resulting new image with a new sidelobe structure that is different from the original sidelobe structure;
normalizing the new complex image by adjusting its intensity such that its peak amplitude matches the peak amplitude in the original complex image;
performing a minimum function of a magnitude of the original complex image and a magnitude of the resulting new complex image; and
producing an apodized image resulting from performing the minimum function.

2. The method of claim 1, further comprising performing a subsequent iteration of the method with a second angle of trimming, wherein the second angle of trimming is different from the first angle.

3. The method of claim 1, further comprising performing a subsequent iteration of the method, wherein the geometric shape comprises a size that is increased or decreased from a prior iteration.

4. The method of claim 1 wherein, the geometric shape is a square.

5. The method of claim 1 wherein, the geometric shape is a triangle.

6. The method of claim 1 wherein, the geometric shape is any regular or irregular, symmetric or asymmetric, two dimensional shape.

7. The method of claim 1 wherein, the geometric shape is a regular or irregular, symmetric or asymmetric, three-dimensional shape.

8. The method of claim 7 further comprising a subsequent iteration wherein the cube is tumbled and data points outside the cube are removed.

9. The method of claim 1 wherein the first angle is forty-five degrees.

10. The method of claim 9 wherein a second iteration is done with a second angle of 22.5 degrees.

11. The system of claim 10 wherein a third iteration is done with a third angle of 67.5 degrees.

12. The system of claim 11 wherein a fourth iteration is done with a fourth angle of 11.25 degrees.

13. The system of claim 12 wherein a fifth iteration is done with a fifth angle of 33.75 degrees.

14. The system of claim 12 wherein a sixth iteration is done with a sixth angle of 78.75 degrees.

15. The system of claim 1 comprising further iterations wherein any set of unique angles is used from iteration to iteration.

16. The system of claim 1 wherein each of the original and new complex images comprise a plurality of image pixels and the minimum function consists of taking for each image pixel in original image and a corresponding image pixel in the new image, the pixel whose absolute value is a minimum.

17. The system of claim 1 wherein the original complex image comprises image pixels, each image pixel comprising a real and an imaginary coordinate, and the minimum function comprises separately taking the minimum of the real and imaginary parts of each image pixel.

18. The system of claim 1 wherein the original complex image comprises image pixels and the minimum function comprises any combination of minimum functions on different image pixels.

19. The system of claim 1 wherein the geometric shape is translated to any set of positions in k-space.

20. The system of claim 1 further comprising one or more subsequent iterations of the method and wherein in subsequent iterations any set of geometric shapes, sizes, rotational angles, and/or translated positions in k-space is used.

21. An apparatus comprising:
an instrument for collecting digital data from an object;
a processor for receiving the digital data and configured to perform the following steps:
receiving an original complex image of an object, the image comprising a plurality of data points some of which form an original sidelobe structure;
transforming the original complex image to a k-space image
trimming the k-space image to remove all points outside a geometric shape, the trimming is done with the shape being at a first angle with respect to the k-space image to produce a trimmed k-space image;
transforming the trimmed k-space image back to complex form to produce a resulting new image with a new sidelobe structure that is different from the original sidelobe structure;
normalizing the new complex image by adjusting its intensity such that its peak amplitude matches the peak amplitude in the original complex image;
performing a minimum function of a magnitude of the original complex image and a magnitude of the resulting new complex image; and
producing an apodized image resulting from performing the minimum function.

22. A method for determining the presence of a manmade object in an image comprising:
receiving an original complex image of a scene having a manmade object, the complex image comprising a plurality of data points, some of the data points forming an original sidelobe structure;
transforming the original complex image to a k-space image, and the trimming producing a trimmed k-space image;
trimming the k-space image to remove all points outside a geometric shape, the trimming being done with the shape being at a first angle with respect to the image, wherein the trimming produces a trimmed k-space image;
transforming the trimmed k-space image back to complex form to produce a resulting new complex image comprising a new sidelobe structure different from the original sidelobe structure;
normalizing the new complex image by adjusting its intensity such that its peak amplitude matches a peak amplitude in the original image;
performing a minimum function of a magnitude of the original complex image and a magnitude of the resulting new complex image;
producing an apodized first image resulting from performing the minimum function;
repeating the above steps and translating the trimmed k-space image in k-space before trimming, producing a different apodized second image;
determining that at least one data point is present in the apodized first image but not in the apodized second image, or vice-versa; and
determining that the at least one data point corresponds to an object that may be a manmade object.
